(19) United States
(12) Patent Application Publication
(10) Pub. No.: US 2002/0067263 A1
(43) Pub. Date: Jun. 6, 2002

(54) Method of performing an inventory of medical instruments

(76) Inventors: Benedict J. Tafoya, Charlestown, MA (US); Albert C. Flanders, Charlestown, MA (US)

Correspondence Address: Anthony M. Lorusso, LORUSSO & LOUD, 440 Commercial Street, Boston, MA, 02109, US

(21) Appl. No.: 09/738,278

(22) Filed: Dec. 13, 2000

Related U.S. Application Data
(60) Provisional application No. 60/170,339, filed on Dec. 13, 1999.

(51) Int. Cl. G08B 13/14

(52) U.S. Cl. 340/572.1; 340/10.1; 340/825.36; 340/825.49

(57) ABSTRACT

A method of tracking medical surgical instruments using encoded radio frequency tags incorporated in labels which are affixed to each instrument. A database of instruments is maintained at a hospital which may contain identification and status information for each instrument. A standard data format is used in the tags to provide a universal inventory system for medical institutions, medical instrument manufacturers and service companies. The tags may be instantly identified by a microprocessor system having a radio frequency scanner. The scanner may optionally write data to a radio frequency tag. A method of accounting for instruments used in a surgical procedure by performing an electronic radio frequency scanning inventory before a procedure and again before a surgical cavity is closed.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention relates generally to inventory methods wherein electronic scanning means identify inventory items and more particularly wherein the electronic scanning means comprise radio frequency tags and radio frequency tag readers in communication with microprocessor system data bases and still more particularly wherein the inventory method accounts for medical instruments in a medical surgery environment.

It is known that keeping track of surgical instruments during medical surgical procedures is essential to protect surgical patients form the persistent danger of serious injury that may occur if surgical instruments are inadvertently left within the patients body when a surgical cavity is closed. Despite diligence of surgical personnel, such injuries to surgical patients frequently occur

It is a standard practice for surgical personnel to take an inventory of surgical instruments before and after a surgical procedure as a method of ensuring that all instruments have been removed from a surgical cavity before the surgical cavity is closed. The inventory is typically performed by surgical personnel who manually identify each instrument and compare it to a written list. Manual identification of the instruments necessarily occurs one instrument at a time and is therefore excessively time consuming. Human errors which occur during a manual identification inventory procedure are a continuing source of injury to surgical patients.

It is known that electronic means of inventory control are typically used to reduce the time required to perform an inventory procedure. Electronic means have been heretofore impracticable for use in tracking surgical instruments.

Typical electronic inventory systems comprise optical scanning devices wherein a laser emitting component is aimed at an encoded target, typically a bar code tag, which is affixed to an inventory item. A detector device typically receives a light signal that is reflected from the target wherein the an encoded optical pattern in the target causes a reflective pattern in the light signal to correspond to an identification code which is associated with the inventory item. A typical detector device is in electrical communication with a microprocessor system and database. The detector device typically converts the encoded light pattern into an electrical signal representing an identification code that is associated in the database with the inventory item. Such a microprocessor system typically comprises a memory containing a database of information about each inventory item corresponding to each identification code wherein the database includes a location data or status data associated with each item. Microprocessor systems may be programmed to present database information to a user in any number of formats which may be appropriate for any number of inventory procedures.

Optical scanning devices have become a ubiquitous means for maintaining an inventory database. Optical scanning inventory systems have limitations which render them unsuitable for tracking medical instruments during surgical procedures. The encoded targets of optical systems would become unreadable by an optical scanning device when they become occluded by accumulations of blood or any number of other substances which are typically present in a surgical environment. An additional limitation of optical devices is the size of the optical target which is typically too large to be attached to many small surgical instruments.

The time required to perform an inventory using optical scanning devices also renders optical devices impracticable for certain applications. Optical scanning systems require a user to present the inventory item proximate to the scanning device and orient the target to the scanning device. Each item must be presented to the scanning device sequentially. The time required to perform an inventory of a large number of items using optical scanning inventory system could be substantial.

Significantly, optical scanning inventory systems leave significant opportunity for human error. For example, if a user presents an instrument to an optical scanner when the target is not properly oriented the optical scanner will not detect the target. Typical optical scanning devices alert the user by emitting a visible or audible signal when a target has been detected. However, if a user becomes distracted or ambient noise degrades the user's ability to detect the alert signal, an inventory item may pass the scanning device without being accounted for. Medical surgical environments are typically filled with alert signals and noise that may increase the probability of such errors If an instrument is not detected in a pre-surgery inventory procedure it may be left within a surgical cavity and would escape detection by a post surgery inventory procedure.

It is known that various embodiments of radio frequency tags are used in inventory control systems. Radio frequency tags typically comprise electronic circuit disposed on small substrate materials. The electronic circuits are capable of carrying encoded data and transmitting the encoded data as a radio frequency signal through space when an interrogation radio frequency signal causes the electronic circuit to enter an active mode. Some embodiments of radio frequency tags are capable of having their data modified by an encoded radio signal.

Typically, a directional radio frequency emitter/receiver is in electrical communication with a microprocessor system having a database of coded inventory information. The emitter/receiver interrogates radio frequency tags that fall within its range by emitting radio frequency waves of a specific frequency. Each tag may respond to a unique interrogation frequency. Once interrogated, a typical radio frequency tag responds by emitting coded information as a radio frequency signal. The emitter/receiver detects the radio frequency signal from the radio frequency tag and causes the microprocessor system to change the data in the database in a programmed response to account for the presence of the inventory item.

Radio frequency tag systems have several advantages over optical scanner systems. First, the radio frequency emitter/detectors are not required to be aimed directly at a tag in order to detect a signal. Radio frequency tag systems will not suffer degraded performance if the tag becomes obscured by any material including blood. The tag may be imbedded in an inventory item or otherwise enclosed and will still be detected as long as radio waves having the appropriate frequencies can penetrate the enclosure.

Secondly, the radio frequency tag microprocessor system is capable of performing an inventory of a large group of items in a very short period of time by sequentially interrogating a tag associated with each item without requiring the user to perform multiple procedural steps. Each reading may take only a small fraction of a second.

It is known to maintain an inventory of library books using radio frequency tags imbedded in the binding of each book. It is further known to maintain an inventory of laundry items at a dry cleaning establishment by using radio frequency tags that are affixed to clothes hangers.

It is heretofore unknown to maintain an inventory of surgical instruments during medical surgical procedures by attaching an encoded radio frequency tag to each instrument, interrogating the radio frequency tags in a surgical area using a radio frequency scanning device and communicating the signals which are detected from the radio frequency tags to a microprocessor system which is programmed to facilitate rapid accounting of specific sets of instruments and alert users of instruments which are not accounted for.

Frequently hospitals and service companies have difficulty keeping track of surgical instruments which are sent to third parties for sterilization and other service procedures. Instruments are often misplaced and costly searches are performed to determine which department or institution is the proper destination for a particular instrument. Traditional inventory methods require costly labor to track individual instruments and are often inaccurate. Typically instruments are counted but are not individually identified in an inventory system because the cost of identifying each instrument is prohibitive. Additional information associated with the identity of each instrument, such as age, manufacturer, history of use and history of maintenance or cleaning, would be useful to an medical institution. Maintaining such additional information associated with the identity of each instrument is not practical using traditional inventory systems.

Inventory systems which use optical scanners may reference databases associated with the identity of individual instruments. However, optical scanning is inefficient because excessive time is required to perform optical scanning of each instrument and the size of optical targets prohibits their use on many small instruments. Optical scanning is further limited because data contained in an optical target tag can not be modified electronically. An optical scanner is capable of only reading the information in a target and may not write additional information or change the information contained in the target. Any data of optically encoded inventory must therefore be maintained in a large central database. Individual database systems, for example the database of a service company, must be in electronic communication with a central database in order to read updated information associated with an instrument. More importantly, the central database of an optical scanning inventory system must be in electronic communication with each scanning device that may read an instrument's target tag in order to update the database to record the scanning event.

An inventory system wherein the data contained in each tag is capable of being easily modified would be more flexible and would allow each instrument to be tracked by any number of smaller databases. Such smaller databases could update data within the tag and need not be in electronic communication with each other or with a central database.

A standard data format would be useful to encode information in modifiable read/write medical instrument tags because a proliferation of non-standard data formats in the tags would significantly degrade the potential utility of inventory systems using such tags. For example, the tagged instruments may be supplied by many vendors for use at many institutions and may be serviced by many service companies. If multiple formats are used then each vendor, institution or service company would be required to maintain and integrate multiple inventory systems. A standard data format would allow efficient universal access to the inventory system.

### BRIEF SUMMARY OF THE INVENTION

Accordingly, the invention described and claimed herein relates to a method of maintaining an inventory of medical instruments wherein a radio frequency identification tag is affixed to or associated with each medical instrument. Data associated with the identification of each instrument is electronically encoded and maintained in an electronic memory within each tag. A database of information associated with an inventory of instruments is compiled and maintained in the electronic memory of at least one microprocessor system. Any number of radio frequency scanners may read the encoded information that is contained in each tag. Each microprocessor system may be programmed to update a database in order to record data associated with each scanning event of each instrument. Any number of microprocessor systems may be programmed to cause a writing device to modify the data which is encoded in each identification tag.

A standard data format is used to encode the data contained in each radio frequency tag. A registry of surgical instrument manufacturers may be maintained so that useful information associated with that manufacturer, for example identity of manufacturer, part number, description, serial number, may be encoded into each tag at an instrument manufacturing plant which is capable of being decoded by scanning device at a hospital and any number of other locations. Writeable memory space within each tag is provided so that the hospital or other user may add additional information such as a user serial number to each tag.

A computer program in communication with a database may control at least one microprocessor system in electronic communication with a radio frequency scanner to perform an inventory of surgical instruments during a medical surgical procedure. The program may cause the microprocessor system to alert operating room personnel if an incomplete or incorrect set of instruments is provided for any specific surgical procedure. The program may also ensure that no instruments are inadvertently left within a surgical cavity by alerting operating room personnel when a post-surgery inventory does not match a pre-surgery inventory of medical instruments. A scanner may be used to rapidly scan a surgical cavity to check for the presence of any instrument.

A primary advantage of the present invention is to provide a fast and efficient method for medical operating room personnel to perform an inventory of medical instruments and especially to ensure that no medical instruments are inadvertently left within a surgical cavity.

A further primary advantage of the present invention is to provide a fast and efficient inventory system of medical instruments for use by hospitals and other institutions as well as their vendors and suppliers.

A still further primary advantage of the present invention is to maintain a registry of surgical instrument manufacturers and assign each manufacturer a unique identification code to facilitate universal use of a standard data format within each medical instrument tag.

### BRIEF DESCRIPTION OF THE SEVERAL VIEWS OF THE DRAWING

FIG. 1 is an exploded view of an embodiment of a radio frequency tag in a label as used according to at least one embodiment of the invention.

FIG. 2 is perspective view of a label having a radio frequency tag as used according to at least one embodiment of the invention.

FIG. 3 is a detail perspective view of a medical instrument having a label with a radio frequency tag as used according to at least one embodiment of the invention.

FIG. 4 is a schematic view of a specific set of medical instruments having radio frequency tags together with a radio frequency scanner as used according to at least one embodiment of the invention.

FIG. 5 is a schematic view of a specific set of medical instruments having radio frequency tags together with a radio frequency scanner and a microprocessor system in a medical operating room as used in at least one embodiment of the invention.

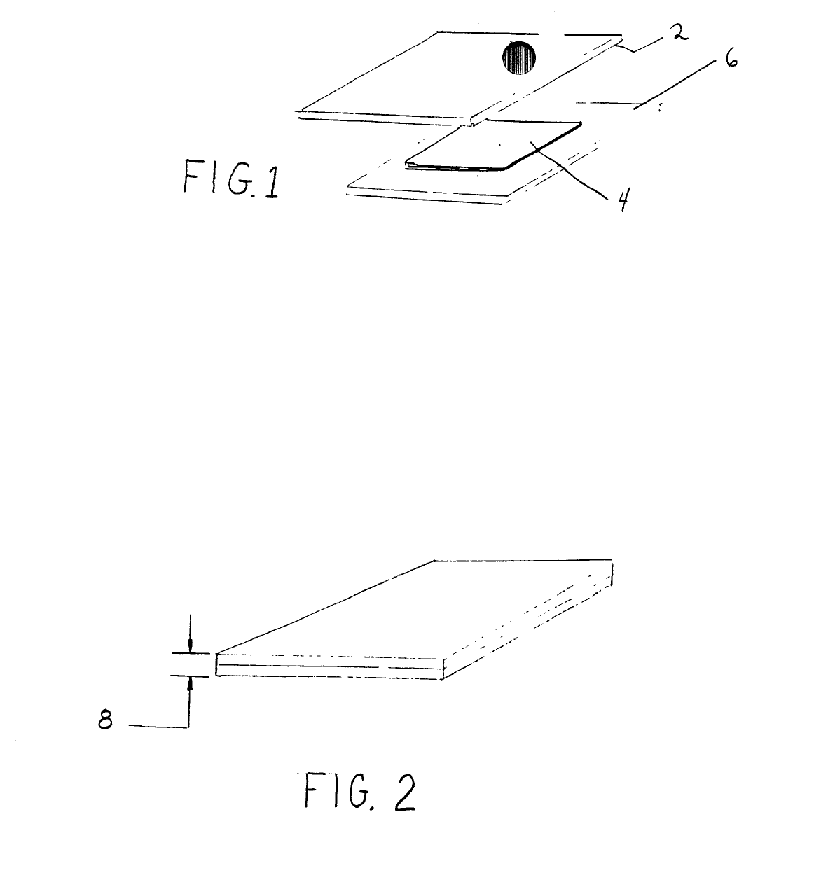

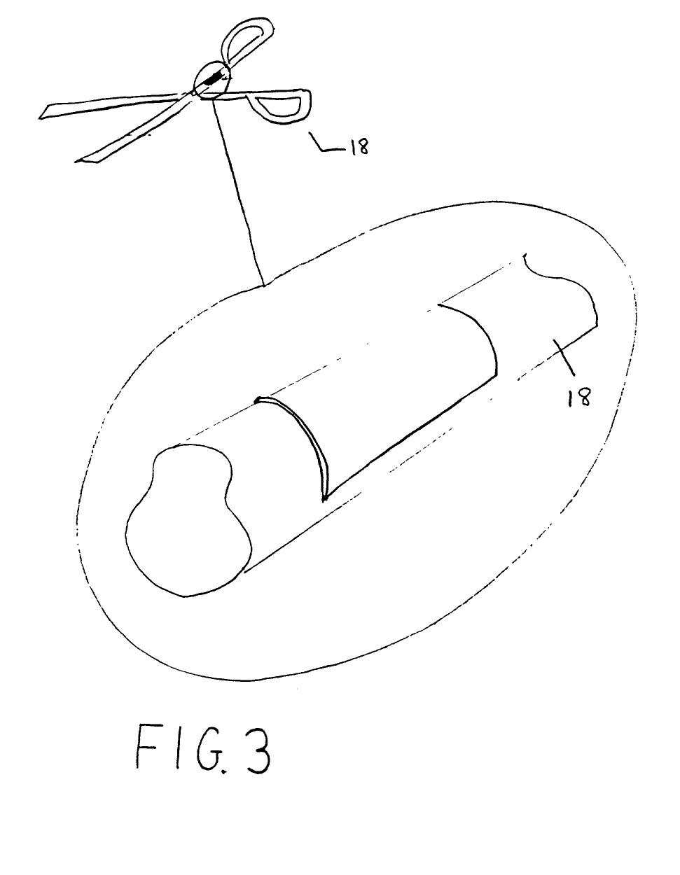

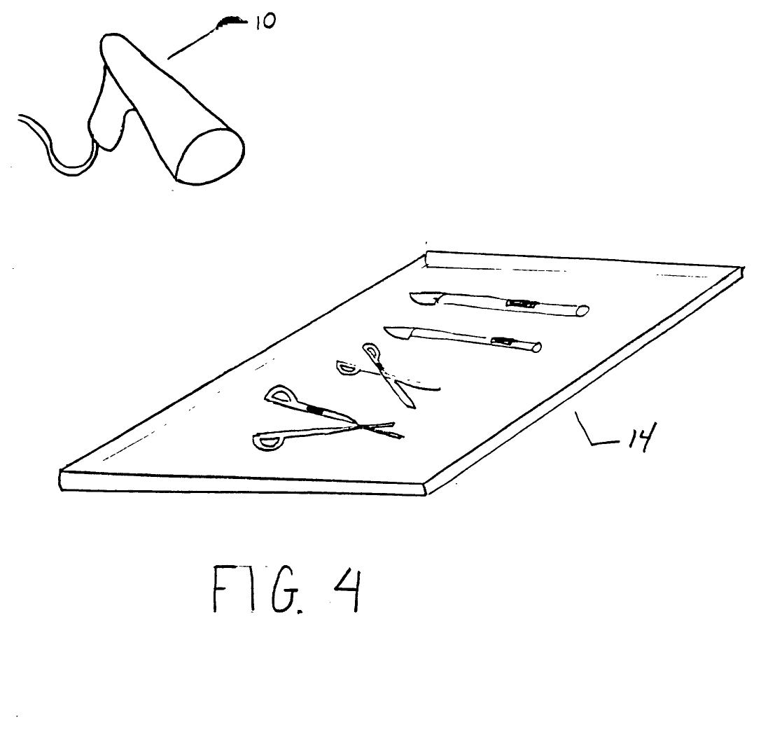

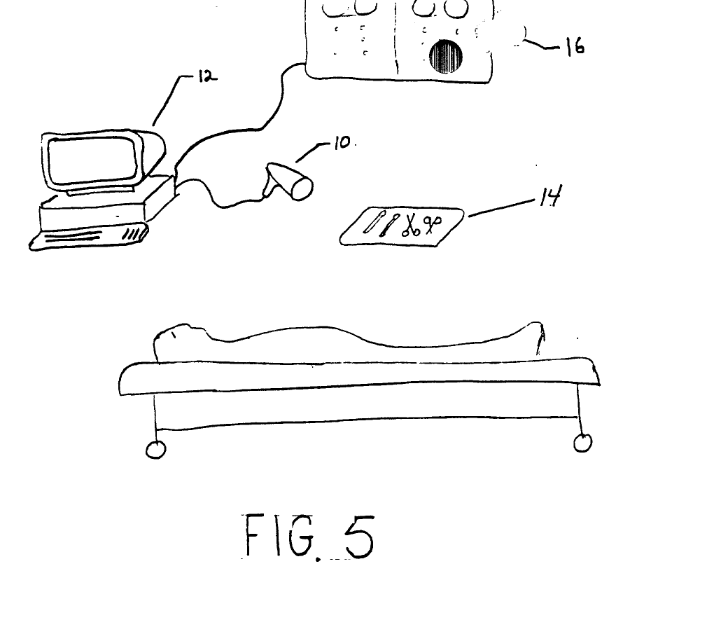

### DETAILED DESCRIPTION OF THE INVENTION

The preferred embodiment of the present invention comprises a radio frequency tag 4 disposed between an outside layer 2 and an adhesive layer 6 of a label. The total thickness 8 of the combined radio frequency tag 4, the outside layer 2 and the adhesive layer 4 of the label is about 0.006 inches. The adhesive layer and outside layer are made from materials which are chosen to withstand the harsh environments which medical instruments endure during cleaning operations while maintaining attachment to the medical instruments.

An electronic code is written to an electronic memory in each radio frequency tag 4 wherein the code represents identification and status data of the medical instrument to which the tag is attached. The data is capable of being read by a radio frequency scanner 10 which is in communication with a microprocessor system 12 wherein the microprocessor system is capable of reading and updating a database of information associated with a large number of inventory items. The radio frequency tag 4 is a read/write tag wherein the data in each tag is capable of being modified by a an electronic writing device. In the preferred embodiment, a radio frequency scanner 10 serves as both a reading device and an electronic writing device.

In the preferred embodiment of the present invention, a registry service provider maintains a registry of surgical instrument manufacturers. Each manufacturer is given an identifier code. The identifier code is incorporated as part of the data which is stored in the memory of each tag. Additional bytes of memory space within each tag are available so that a manufacturer may encode a part number and description of each instrument into its tag. Additional writeable memory space is provided on each tag so that a user identification code may be written to the tag when an instrument is received at a hospital or other end user location.

A database of information associated with a large number of instruments may be maintained at a hospital or other institution. The database may be controlled and updated by using a microprocessor system which is electronic communication with any number of radio frequency scanners. Additional databases may be maintained at medical instrument manufacturers, suppliers or service companies which may be in electronic communication with any number of radio frequency scanners and with other databases.

In the preferred embodiment, a database of surgical procedures is correlated to a database of specific sets of instruments 14 which are required for each surgical procedure. A computer program is in communication with a radio frequency scanner 10 and with the surgical procedure database 16 and controls a microprocessor system 12. The program provides means for hospital personnel to scan a set of instruments 14 which are collected for a specific procedure and ensure that the correct instruments are contained in the set 14. The program may cause the microprocessor system 12 to alert a user if a required instrument is not detected by a scan of the set 14.

In the preferred embodiment, a computer program controls a microprocessor system 12 which is in electronic communication with a database 16 of medical instrument information and in with a radio frequency scanner 10. The present invention comprises a method of performing a surgical procedure with instruments 18 having radio frequency identification tags affixed thereto as a means to ensure that no medical instrument is inadvertently left within a surgical cavity. Using the method of the prefcrred embodiment, hospital personnel would scan a set of instruments 14 before a medical surgical procedure, perform the surgical procedure using the scanned instruments and scan the instruments again before closing any surgical cavity. The computer program causes components of the microprocessor system 12 to alert hospital personnel when a pre-surgery inventory scan does not match a post-surgery inventory scan.

I claim:

1. A medical surgical instrument having a radio frequency tag affixed thereto wherein said radio frequency tag caries data which identifies said medical surgical instrument and wherein said data is readable by a radio frequency scanner.

2. A medical surgical instrument according to claim 1 wherein said radio frequency tag comprises a label wherein said label comprises an outside layer and an adhesive layer.

3. A medical surgical instrument according to claim 2 wherein said label and said radio frequency tag have a combined thickness of about 0.006 inches.

4. A method of performing a medical surgical procedure and maintaining an inventory of the medical instruments used during the surgical procedure comprising:
providing a plurality of surgical instruments each of which has a radio frequency identification tag affixed thereto;
scanning each of said instruments prior to beginning the surgical procedure to obtain an inventory;
performing the surgery by using the instruments that have been scanned and inventoried;
scanning each of said instruments prior to closing any surgical cavity to accertain that all instruments have been accounted for; and
closing any surgical cavity.

5. A method of accounting for surgical instruments used in a medical surgical procedure comprising:
providing a plurality of surgical instruments each of which has a radio frequency identification tag affixed thereto;
performing the surgery using said surgical instruments;
directing a scanning device toward any surgical cavity;
detecting the presence of any surgical instrument in the area of any surgical cavity by operating said scanning device.

6. A data format for organizing data within a memory space of a radio frequency tag wherein said data format requires a unique code to fill a particular memory space wherein said unique code is a registered identification code associated with a particular medical instrument manufacturer.

7. The data format according to claim 6 further comprising additional blocks of memory allocated for coded data which are associated with an instrument description, an instruments use, an instruments part number an instrument serial number and an instrument user identification code.

8. A method of providing medical instrument manufacturers with unique identification codes for use in medical instruments having radio frequency tags comprising:
providing a medical instrument manufacturers registration service wherein said service comprises: maintaining a database of codes associated with each registered medical instrument manufacturer;
distributing a unique identification code to each manufacturer who requests to be registered;
suppling a list of registered manufacturers and their corresponding identification codes to hospitals and any other end user of radio frequency tagged inventory systems who may request said list.

9. A computer program which is capable of controlling a microprocessor system wherein said microprocessor system is in communication with a database having data which correlates a list of any number of surgical procedures to a set of surgical instruments which is required to perform said surgical procedure and wherein said surgical instruments are identified within said database by an identification code associated which is associated with an identification code contained in a radio frequency tag attached to or associated to each instrument and wherein said microprocessor system is also in electronic communication with a radio frequency scanner and wherein said computer program is capable of causing the microprocessor system to perform the steps of:
presenting a list of surgical procedures to a user;
waiting for a user to choose at least one surgical procedure from said list;
allowing a user to enter an input to identify at least one chosen procedure;
prompting a user to scan a set of tagged medical instruments with a radio frequency scanner;
reading identification codes for each instrument scanned from a radio frequency scanner;
comparing the data of scanned instruments to data of instruments required for the selected surgical procedure;
alerting the user if all of the correct instruments are present in the scanned set;
alerting the user if all of the correct instruments are not present in the scanned set and providing the user with a list of instruments which are not present that are required for the selected procedure.
